(19) United States
(12) Patent Application Publication
(10) Pub. No.: US 2012/0176881 A1
(43) Pub. Date: Jul. 12, 2012

(54) OPTICAL PICKUP DEVICE AND OPTICAL DISC APPARATUS APPLYING THE SAME

(75) Inventors: Seong-su PARK, Hwaseong-si (KR); Soo-han PARK, Yongin-si (KR); Jung-woo HONG, Suwon-si (KR); Se-june PARK, Seoul (KR); Dong-jin SHIN, Suwon-si (KR); Ichiro MORISHITA, Yokohama (JP)

(73) Assignee: SAMSUNG ELECTRONICS CO., LTD., Suwon-si (KR)

(21) Appl. No.: 13/303,393

(22) Filed: Nov. 23, 2011

(30) Foreign Application Priority Data
Jan. 10, 2011 (KR) 10-2011-0002398

(51) Int. Cl. G11B 7/135

(52) U.S. Cl. 369/112.16; G9B/7.117

(57) ABSTRACT

An optical pickup device is provided. The device includes a semiconductor laser light source which outputs linearly-polarized light having an elliptical shape, an objective lens which focuses light outputted from the semiconductor laser light source, forming an optical spot on an optical disc; and a polarization plate which is disposed placed on an optical path between the semiconductor laser light source and the objective lens, and which polarizes the light outputted from the semiconductor laser light source and transmits elliptically-polarized light, wherein the polarization plate is disposed such that a major axis of the elliptical polarization of the light transmitted by the polarization plate is parallel to or perpendicular to a major axis of the elliptical shape of the light.

### CROSS-REFERENCE TO RELATED APPLICATIONS

This application claims priority under 35 U.S.C. §119 from Korean Patent Application No. 10-2011-0002398, filed on Jan. 10, 2011, in the Korean Intellectual Property Office, the disclosure of which is incorporated herein by reference in its entirety.

### BACKGROUND

1. Field

Apparatuses and methods consistent with exemplary embodiments relate to an optical pickup device and an optical disc apparatus including the same, and more particularly, an optical pickup device which may adjust the shape of an optical spot by using a polarization plate and an optical disc apparatus including the same.

2. Description of the Related Art

In accordance with the development of image and audio storage media, a disc which can record/store high definition image information and high quality audio information for a long period of time has been developed and commercialized.

The disc is a recording medium which can record and/or reproduce data by forming numerous pits on the surface thereof, thereby altering a reflection of a laser beam from the surface of the disk. A Compact Disc (CD) or a Digital Versatile Disc (DVD) are examples of optical discs. However, such discs have limited recording capacities, and new discs such as recordable/rewritable Blu-ray discs (BDs) and High Density DVDs (HD DVDs), which can record a large amount (i.e. more than tens of Gigabytes) of information, have been developed.

The quantity of the information which is recordable on various types of discs is inversely proportional to the size of the optical spot formed on the disc, and the area (S) of the optical spot is determined by the wavelength (λ) of the laser beam and the numerical aperture (NA) of the objective lens as below:

$$S ∝ k \times \frac{λ}{NA}$$

where k is a constant dependent on the optical system and its value is generally 1 to 2.

Accordingly, in order to record a large amount of information on the disc, the area (S) of the optical spot formed on the disc should be reduced. To do this, the wavelength (λ) of the laser beam should be decreased or the NA should be increased as represented in the above-noted relationship.

That is, to increase an amount of data stored on a disc, a light source having a shorter wavelength and/or an objective lens having a larger numerical aperture is used. For example, to record on a CD, a light source outputting near-infrared light having a wavelength of 780 nm and an objective lens having an NA of 0.45 may be used. For recording on a Digital Versatile Disc (DVD), having a recording capacity approximately 6 to 8 times that of a CD, a light source outputting red light having a wavelength of 650 nm (or 630 nm) and an objective lens having an NA of approximately 0.6 (or 0.65 for a recordable DVD) may be used. For recording on a BD, a light source outputting green light having a short wavelength (405-408 nm) and an objective lens having an NA of approximately 0.85 may be used.

An optical pickup device is a device which records information by applying a laser beam to a signal recording layer of a disc and/or reproduces information recorded on the disc by receiving light reflected from the signal recording layer of a disc in a non-contact manner. The signal quality of the reproduced information is related to the shape of the spot on the disc, and it is desirable to have a small circular optical spot.

In order to miniaturize the size of the spot formed on the disc, a related art optical pickup device maintains the ellipticity of 90% or more for a quarter wave plate by amending the angle of a half wave plate which changes the polarization direction of the light according to the angle of a laser diode which generates a laser beam and by focusing the spot on the disc passed through the quarter wave plate to a circular polarization.

Thus, an optical pickup device may use the combination of a half wave plate and a quarter wave plate to output circularly-polarized light to form a miniaturized spot on the disc instead of using the linearly-polarized light a generated by a laser diode. However, such optical pickup devices do not take into consideration the radiation angle property of the laser diode or the double refraction effect of the disc. Therefore, when a semiconductor laser is used, an elliptical optical spot having a major/minor axis ratio (diameter ratio) is formed due to the difference of the radiation angles. Accordingly, the diameter ratio of the spot on the disc may be a value other than 1 and thus, as variously sized discs exist on the market, it would be difficult for users to select and store information without confirming the compatibility of the discs.

Thus, it is desired to provide an optical pickup device capable of decreasing the size of the optical spot.

### SUMMARY OF THE INVENTION

According to an aspect of an exemplary embodiment, an optical pickup device and an optical disc apparatus applying the same are provided. The optical pickup device includes a polarization plate, which is disposed on an optical path between a semiconductor laser light source and an objective lens, polarizes the light outputted from the semiconductor laser light source and transmits elliptically-polarized light, and is disposed such that a major axis of the elliptical polarization of the light is be parallel or perpendicular to a major axis of the light.

According to an exemplary aspect of another exemplary embodiment, there is provided an optical pickup device including a semiconductor laser light source which outputs linearly-polarized light having an elliptical shape, an objective lens which focuses light outputted from the semiconductor laser light source, thus forming an optical spot on an optical disc, and a polarization plate which is disposed on an optical path between the semiconductor laser light source and the objective lens, and which polarizes the light outputted from the semiconductor laser light source and transmits elliptically-polarized light, and is disposed such that a major axis of the elliptical polarization of the light is parallel to a major axis of the elliptical shape of the light.

The polarization plate may have a phase difference such that the optical spot formed by the objective lens has a circular shape.

The polarization plate may have a phase difference of which range is more than ¼λ and equal to or less than 3/10λ, where λ is a wavelength of the light outputted by the semiconductor laser light source.

The polarization plate may have a phase difference such that a ratio of a major axis of the optical spot to a minor axis of the optical spot is equal to or greater than 0.9 and equal to or less than 1.

The major axis of the elliptical shape of the light and the major axis of the elliptical polarization may be parallel to an information track direction of the optical disc.

The objective lens may have a numerical aperture of 0.85 or more.

According to an aspect of another exemplary embodiment, an optical disc apparatus includes an optical pickup device as described above.

According to an aspect of another exemplary embodiment, an optical pickup device includes a semiconductor laser light source which outputs linearly-polarized light having an elliptical shape, an objective lens which focuses light outputted from the semiconductor laser light source, thus forming an optical spot on an optical disc, and a polarization plate which is disposed on an optical path between the semiconductor laser light source and the objective lens, and which polarizes the light outputted from the semiconductor laser light source and transmits elliptically-polarized light, and is disposed such that a major axis of the elliptical polarization is be perpendicular to a major axis of the laser beam.

The polarization plate may have a phase difference such that in which a major axis of the optical spot is perpendicular to an information track direction of the optical disc.

The polarization plate may have a phase difference which is more than ⅕λ and equal to or less than ¼λ, where λ is a wavelength of the light outputted by the semiconductor laser light source.

The objective lens may have a numerical aperture of 0.85 or more.

According to an aspect of another exemplary embodiment, an optical disc apparatus comprises an optical pickup device as described above.

As described above, aspects of one or more exemplary embodiments provide an optical pickup device and an optical disc apparatus applying the same. The optical pickup device includes a polarization plate which is disposed on an optical path between the semiconductor laser light source and the objective lens, polarizes the light outputted from the semiconductor laser light source and transmits elliptically-polarized light, and is disposed such that a major axis of the elliptical polarization of the light transmitted by the polarization plate is parallel or perpendicular to a major axis of the light. According to aspects of exemplary, the optical spot may have a circular shape, which may improve the jitter or cross torque.

According to aspects of one or more exemplary embodiments, the major axis of the optical spot is perpendicular to a track direction of a BD optical disc, thereby enabling an optical device to reduce the spot diameter in a track direction.

### BRIEF DESCRIPTION OF THE DRAWINGS

The above and/or other aspects will be more apparent from the following description of exemplary embodiments with reference to the accompanying drawings, in which:

FIG. 1 is a perspective view schematically showing an optical configuration of an optical pickup device according to an exemplary embodiment;

FIG. 2. is a top view of an optical pick device according to an exemplary embodiment;

FIG. 3 illustrates the concentration (focus) of light transmitted through an objective lens having a low NA when the light incident on the objective lens is polarized in an x direction;

FIG. 4 illustrates the concentration (focus) of light transmitted through an objective lens having a high NA when the light incident on the objective lens is polarized in an x direction;

FIG. 5 illustrates the concentration (focus) of light transmitted through an objective lens having a low NA when the light incident on the objective lens is polarized in a z direction;

FIG. 6 illustrates a concentration (focus) of light transmitted through an objective lens having a high NA when the light incident on the objective lens is polarized in a z direction;

FIG. 7 illustrates a distribution of a light-intensity according to a polarization direction;

FIG. 8 depicts a relationship between the diameter ratio of the optical spot and an ellipticity of the elliptical polarization when the NA is 0.95;

FIG. 9 depicts a relationship between the diameter ratio of the optical spot and the ellipticity of an elliptical polarization when the NA is 0.85;

FIG. 10 depicts a relationship between the ellipticity of the optical spot and the NA of the objective lens;

FIG. 11 depicts a shape of an optical spot according to each type of polarization when the NA of the objective lens is 0.85;

FIG. 12 depicts a shape of the polarization according to a phase difference of a polarization plate according to an exemplary embodiment; and

FIG. 13 is a table representing the shape of the optical spot according to a phase difference of the polarization plate according to an exemplary embodiment.

### DETAILED DESCRIPTION OF THE INVENTION

Certain exemplary embodiments will now be described in greater detail with reference to the accompanying drawings.

In the following description, the same drawing reference numerals are used for the same elements even in different drawings. The matters described herein, such as detailed construction and elements, are provided to assist in a comprehensive understanding of the exemplary embodiments. Thus, it is apparent that exemplary embodiments can be carried out without those specifically defined matters. Also, well-known functions or constructions are not described in detail since they would obscure the description with unnecessary detail.

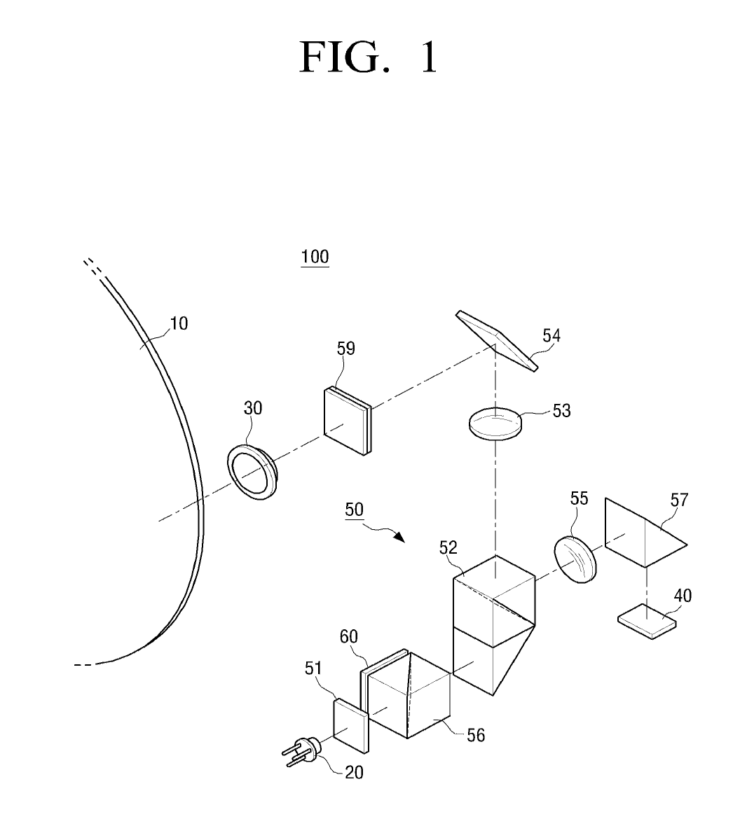

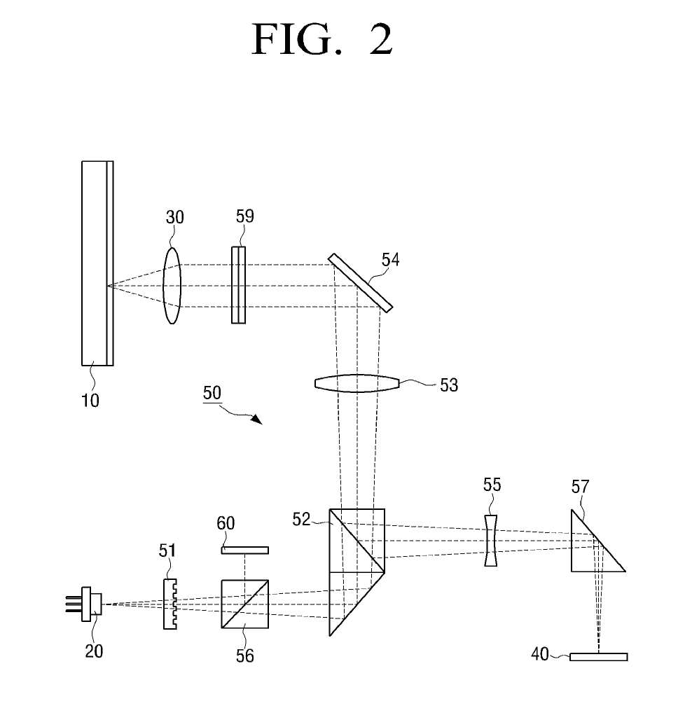

FIG. 1 is a perspective view schematically showing a configuration of an optical pickup device according to an exemplary embodiment. FIG. 2 is a top view showing a disposition of an optical pickup device according to an exemplary embodiment.

An optical pickup device 100 is a device which records information by making a laser beam incident onto a signal recording layer of the disc and/or reproduces information recorded on the disc by receiving light reflected from the signal recording layer of the disc in a non-contact manner.

As illustrated in FIGS. 1 and 2, the optical pickup device 100 includes a semiconductor laser light source 20, an objective lens 30, an optical detector 40, and an optical path converter 50. an optical disc is illustrated as element 10.

The optical disc 10 is a disc which data is recorded onto and/or read from using a laser beam. Examples of the optical disc 10 are a CD, a DVD, a BD, or the like as would be understood by one of skill in the art.

The semiconductor laser light source 20 emits a semiconductor laser beam having a wavelength corresponding to a format of the optical disc used. Particularly, the semiconductor laser light source 20 emits a linearly-polarized laser beam having an elliptical shape (i.e. a cross-sectional shape of the laser beam is elliptical).

The objective lens 30 forms a light spot on the signal recording layer of the optical disc 10 by focusing the light emitted from the light source 20.

The light detector 40 receives light reflected from the optical disc 10 to detect an information signal and/or an error signal.

The optical path converter 50 directs the optical path of the light.

The optical disc 10 may be any of various types and the laser light source 20 may emit a wavelength based on a recording density that differs according to the type of disc used. For example, if the optical disc 10 is a BD, the semiconductor laser light source 20 emits laser beam having a wavelength in a blue region which satisfies the standard of the BD. In this case, the objective lens 30 may have an NA of approximately 0.85.

Thus, the semiconductor laser light source 20 emits light having a wavelength in a blue region, and if the objective lens has an NA of 0.85, the optical pickup device may record data onto and/or reproduce data from the disc 10 according to the BD standard.

The light detector 40 is may be a photo diode integrated circuit which receives the reflected light from the plane (signal recording layer) of the disc 10 and detects an information signal and/or an error signal.

The optical path converter 50 directs the light emitted from the semiconductor laser light source 20 towards the objective lens 30 and directs the light reflected from the optical disc 10 towards the optical detector 40.

The optical path converter 50 includes a grating 51 which separates the light emitted from the semiconductor laser light source 20 into 3 beams, a polarization beam splitter 52 which alters the path of the light according to the polarization direction thereof, a collimating lens 53 which collimates the light received from the polarization beam splitter 52, a reflecting mirror 54 which bends the path of the light, an astigmatic lens 55 which generates an astigmatism, a first splitter 56 which is installed between the grating 51 and the polarization beam splitter 52 and which transmits the light received from the grating 51 to the polarization beam splitter 52, and a second splitter 57 which is installed between the astigmatic lens 55 and the light detector 40 and transmits the light received from the astigmatic lens 55 to the light detector 40.

The grating 51 may be a diffraction grating which separates the light outputted from the semiconductor laser light source 20 into three beams: a 0 order beam (main light) and ±1 order beams (sub light) to detect a tracking error signal according to a 3 beam method or a DPP method. The 0 order beam formed by the grating 51 may provide a reproduction signal. The 0 order beam and the ±1 order beams formed by the grating 51 may also be used to track an error signal by applying an arithmetic operation to the 0 order beam and the ±1 order beams reflected from the optical disc 10.

Moreover, the optical path converter 50 further includes a polarization plate 59 which is disposed on an optical path between the semiconductor laser light source 20 and the objective lens 30 and which alters the polarization of the light transmitted therethrough, and a feed-back photodiode 60 which is used in the control of the light emitted from the light source 20.

The polarization plate 59 polarizes the light outputted from the semiconductor laser light source and transmits elliptically-polarized light. Furthermore, the polarization plate 59 is disposed such that the major axis of the elliptical polarization of the transmitted light is parallel to the major axis of the elliptical shape of the transmitted light. The phase difference of the polarization plate 59 is such that the elliptical-shaped laser beam incident on the polarization plate is transformed so that the light spot on the disc becomes a circular shape.

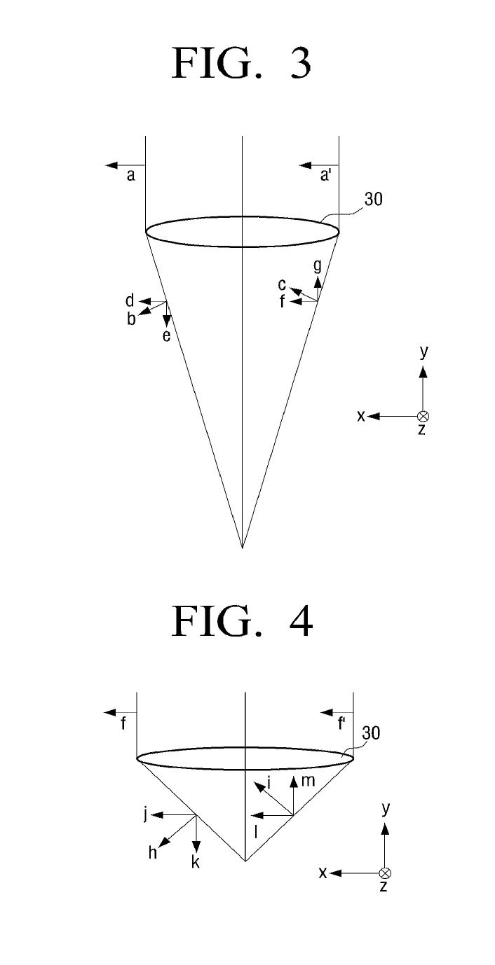

To do this, the polarization plate 59 may have a phase difference of more than ¼ wavelength and equal to or less than 3/10 wavelength. Specifically, the ellipticity of the optical spot, which is affected by the distribution of the light as incident on the objective lens 30, becomes maximum of 0.9. Accordingly, in order to achieve this, the ellipticity of the polarization of the transmitted light should also be approximately 0.9. When the NA of the objective lens is 0.85, the ellipticity of the polarization of the light is 0.7 to 1.0 when the ellipticity of the optical spot (the diameter ratio of the optical spot) is 0.9 or more, as illustrated in FIG. 9 (see the dotted line on the graph representing the ellipticity of the polarization taking into account both the component of the polarization of the light in the direction parallel to the focal plane direction (the x and z directions in FIGS. 3-6) and the component of the polarization of the light in the direction parallel to the optical axis (the y direction in FIGS. 3-6). Also, to make the ellipticity of the polarization be between 0.7 and 1.0, the phase difference of the polarization plate 59 is made to be more than ¼ wavelength and equal to or less than 3/10 wavelength.

Accordingly, if the phase difference of the polarization plate 59 is more than ¼ wavelength and equal to or less than 3/10 wavelength, the optical spot becomes circular or close to a circular shape. That is, the optical spot has an elliptical or circular shape with a diameter ratio (minor axis/major axis) between 0.9 and 1.

Moreover, the polarization plate 59 may be disposed such that the major axis of the elliptical shape of the transmitted laser beam and the major axis direction of the elliptical polarization are parallel to an information track direction of the optical disc 10.

As the polarization plate 59 having the above configuration is located inside the optical pickup device 100, the optical pickup device 100 may form an optical spot in the shape of a circle despite the elliptical-shaped laser beam output by the semiconductor laser light source 20.

It is described above that the NA of the objective lens 30 is 0.85 to satisfy the standard of the BD. However, the objective lens 30 may also have an NA of 0.85 or more.

Hereinafter, the an operation and the effects of the optical pickup device 100 configured as above are described.

The light generated and outputted from the light source 20 is separated into three beams: a 0 order beam (main light) and ±1 order beams (sub light), and the 3 beams are diffracted. A tracking error signal may be detected. The light directed by the polarization beam splitter 52 to the collimating lens 53 is collimated into parallel light as it is transmitted through the collimating lens 53, and the light is incident on the objective lens 30 after being reflected by the reflecting mirror 54. The parallel light is elliptically-polarized upon passing through polarization plate 59, located on the optical path of the light between the light source 20 and the objective lens 30, and the elliptically-polarized light forms the optical spot on the signal recording layer of the disc 10 after passing through the objective lens 30. The optical spot has a circular or substantially circular shape as described herein.

In accordance with the next generation standards of BD, the NA of the objective lens 30 may be 0.85 or more. Accordingly, a method using an objective lens having an NA of 0.85 or more is described below.

In order to raise the modulation degree of the data recorded on the optical disc 10, the diameter of the spot in the information track direction (i.e. linear velocity direction/a circumferential direction) of the optical disc 10 should be decreased. Accordingly, if the optical spot is formed in an elliptical shape having its major axis is in parallel to the radial direction of the optical disc 10 (perpendicular to the information track direction), the spot diameter in relation to the information track direction of the optical spot is decreased.

To achieve this, the polarization plate 59 is disposed such that the major axis direction of the elliptical polarization of the light is perpendicular to the major axis direction of the elliptical shape of the laser beam. Also, the polarization plate 59 has a phase difference which causes the major axis of the ellipse shape of the optical spot to be perpendicular to the information track direction. To do this, the phase difference of the polarization plate 59 should be about ⅕ or more wavelength and less than ¼ wavelength.

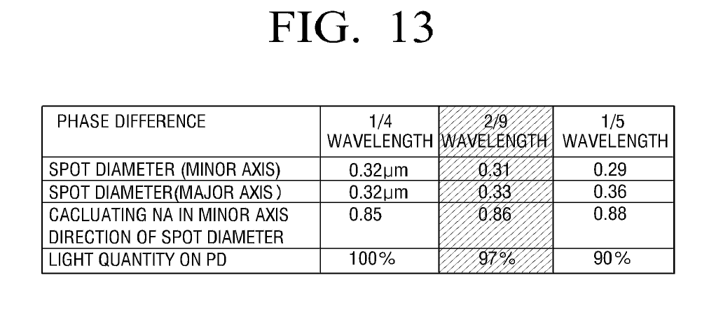

Specifically, FIG. 13 illustrates the shape of the optical spot according to the phase difference of the polarization plate 59 according to an exemplary embodiment, and shows phase differences of ¼ wavelength, 2/9 wavelength, and ⅕ wavelength.

According to FIG. 13, when the phase difference of the polarization plate 59 is ¼ wavelength, the spot diameter along the minor axis is 0.32 μm, when the phase difference of the polarization plate 59 is 2/9 wavelength, the spot diameter of along minor axis is 0.31 μm, and when the phase difference of the polarization plate 59 is ⅕ wavelength, the spot diameter along the minor axis is 0.29 μm. Also, it is observed that the NA in the minor axis direction is increased from 0.85 to 0.88 as the phase difference decreases from ¼ wavelength to ⅕ wavelength.

If the phase difference of the polarization plate 59 is ⅕ wavelength, the light quantity reaching the light detector 40 is reduced to 90%, so a recognition ratio is lowered. However, a phase difference of 2/9 wavelength creates a small spot diameter along the minor axis and also a large amount of light.

However, if the phase difference of the polarization plate 59 is between ⅕ and ¼ wavelength, an effective NA of up to 0.88 may be achieved using an object lens having an NA of 0.85.

Thus, when an optical spot is formed in an elliptical shape with its major axis parallel to the radial direction of the disc (perpendicular to the information track direction), the optical pickup device 100 may obtain the effect of an NA of 0.88 using an objective lens having an actual NA of 0.85.

Hereinafter, the effect of the liner polarization on the spot shape will be described with reference to FIGS. 3 to 6. FIGS. 3 to 6 depict the polarization of the light at the most external portion of the beam according to the NA of the objective lens 30.

FIG. 3 depicts a concentration (focus) of light transmitted through the objective lens 30 having a low NA when the light incident on the objective lens is polarized in the x direction. FIG. 4 depicts a concentration (focus) of light transmitted through the objective lens 30 when the light incident on the objective lens is polarized in the x direction.

In FIG. 3, the polarization direction of the light incident on the objective lens 30 is presented as vectors a and a′, where a=a′, for a low NA, and in FIG. 4, the polarization of the light incident on the objective lens 30 is presented as vectors f and f′, where f=f′, for a high NA. The vectors illustrating the polarization direction of the light change as the light passes through the objective lens 30, such that a=>b, a′=>c, f=>h, and f′=>i.

Here, the vectors b, c, h, and i may be represented as b=d+e, c=f+g, h=j+k, and i=l+m.

As illustrated in FIGS. 3 and 4, vectors e and g, parallel to the y direction, are of equal length and opposite direction, and vectors k and m, parallel to the y direction, are of equal length and opposite direction. Therefore, these vectors offset each other during the spot formation. As the NA of the objective lens is increased, the components of the polarization which cancel each other out, represented by vectors parallel to the y direction (e.g. vectors g and e and vectors m and k), increase and thus, the components of the polarization which cancel each other out increase, and the effect of this cancellation on the spot also increases.

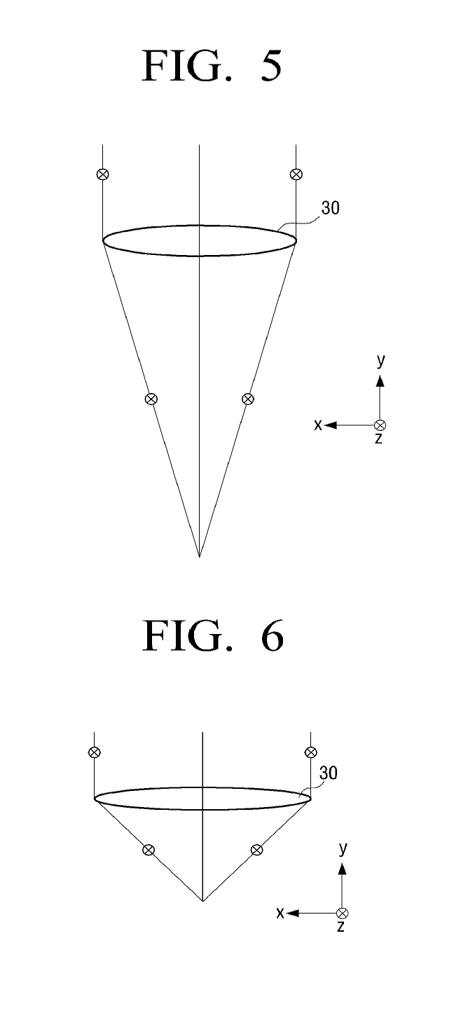

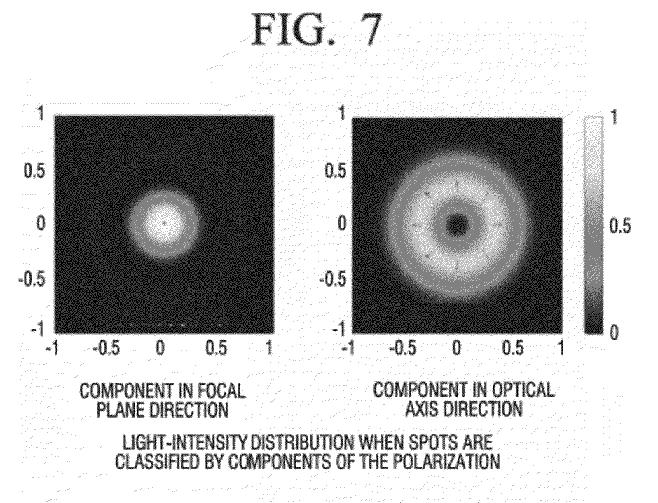

FIG. 5 depicts a concentration (focus) of light transmitted through the objective lens 30 having a high NA when the light incident on the objective lens is polarized in the z direction. FIG. 6 depicts a concentration (focus) of light transmitted through the objective lens 30 having a high NA when the light incident on the objective lens is polarized in the z direction.

As illustrated in FIGS. 5 and 6, the polarization direction of the light polarized in the z direction is not affected as the light is focused by the objective lens 30.

As shown in FIGS. 3 to 6, as the linearly-polarized light is focused by the objective lens, the focusing of the light alters the direction in which the light is polarized, such that components of the polarization (the vectors parallel to the y direction) cancel each other out. As the NA of the objective lens increases, the vectors of the polarization which cancel each other out increase. The components of the polarization which are parallel to the original polarization direction of the light incident on the objective lens do not cancel each other out. The result is that the light transmitted by the objective lens creates an elliptical spot, which effectively causes the size of the spot to increase with an increased NA.

That is, when linearly-polarized light is concentrated/focused by the objective lens 30, the components of the polarization parallel to the y-direction (substantially perpendicular to the plane of the objective lens) cancel each other out, thus weakening the light, while the components of the polarization parallel to the x-direction (substantially parallel to the plane of the objective lens) do not cancel each other out and do not weaken the light.

As shown in FIGS. 3 and 4, as the NA of the objective lens increases, the components of the polarization in the direction parallel to the y direction increase with respect to the components of the polarization in the direction parallel to the x-direction. Therefore, when the NA is between 0.95 and 0.85, the components of the polarization in the direction parallel to the y direction affect the resultant shape of the spot formed on the disc. FIG. 7 depicts such a case.

FIG. 7 depicts a distribution of the light-intensity according to the polarization direction of the light. As illustrated in FIG. 7, the light-intensity of the optical spot may be observed in not only with respect to the component of the polarization in the direction parallel to the focal plane direction (i.e. a direction parallel to the plane of the objective lens—the x or and z directions) but also with respect to the component of the polarization in the direction of the optical axis (i.e. a direction perpendicular to the plane of the objective lens—the y direction). That is, with respect to the component of the polarization parallel to the optical axis (y direction), the center portion of the light is offset, however the surrounding portions of the light is not offset. Accordingly, if the NA is between 0.95 and 0.85, the component of the polarization in the y direction affects the shape of the optical spot.

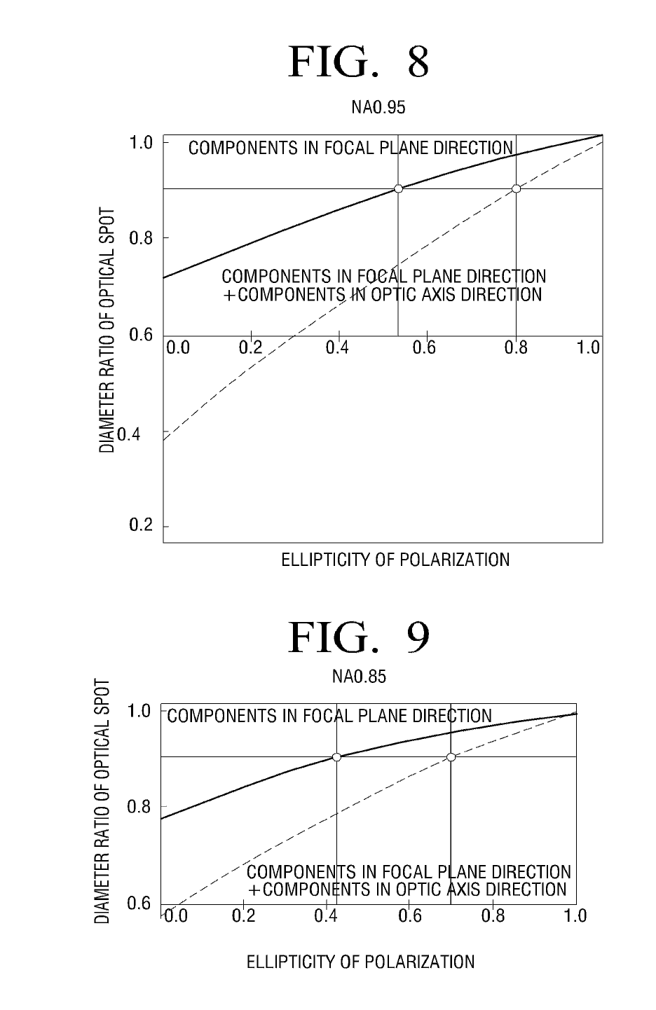

Accordingly, FIGS. 8 and 9 illustrate graphs showing the diameter ratio of the optical spot formed on the disc in relation to the ellipticity of the elliptical polarization of the light, taking into account the sum of the components of the polarization parallel to the focal plane direction (in the x and z directions) and the components of the polarization parallel to the optical axis (in the y direction).

FIG. 8 depicts a relationship between the ellipticity of the optical spot and the ellipticity of the elliptical polarization when the NA of the objective lens is 0.95. FIG. 9 depicts a relationship between the ellipticity of the optical spot and the ellipticity of the elliptical polarization when the NA of the objective lens is 0.85. The diameter ratio of the optical spot in FIGS. 8 and 9 represents the value of “minor axis/major axis” of the elliptically-shaped optical spot formed on the disc.

As illustrated in FIGS. 8 and 9, when considering only the component of the polarization in the direction parallel to the focal plane (the x and z directions), illustrated as a solid line in each of FIGS. 8 and 9, the diameter ratio of the optical spot is lower than when taking into account the combination of the components of the polarization in the direction parallel to the focal plane (the x and z directions) and the components of the polarization parallel to the optical axis direction (the y direction).

Accordingly, a lens having a high NA should be applied to a graph which takes into account both the components of the polarization in the direction parallel to the focal plane and the components of the polarization in the direction parallel to the optical axis.

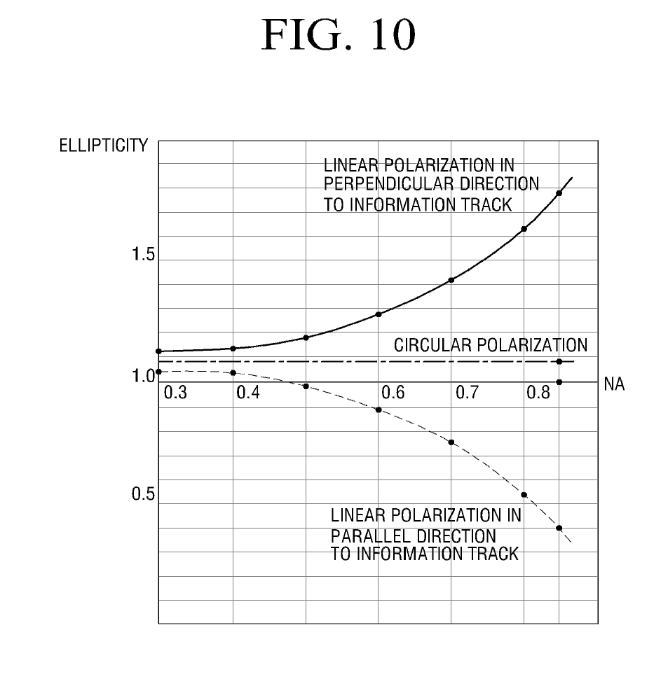

FIG. 10 depicts a relationship between the ellipticity of the optical spot and the NA of the objective lens. As illustrated in FIG. 10, if the NA is low (i.e. between 0.3 and 0.5), the ellipticity of the optical spot is not significantly affected by the type of the polarization of the light incident on the objective lens. However, as the NA is increased, the ellipticity of the optical spot is more and more affected by the type of the polarization of the light incident on the objective lens.

That is, it may be observed through FIG. 10 that the effect that the polarization has is increased as the NA of the objective lens increases.

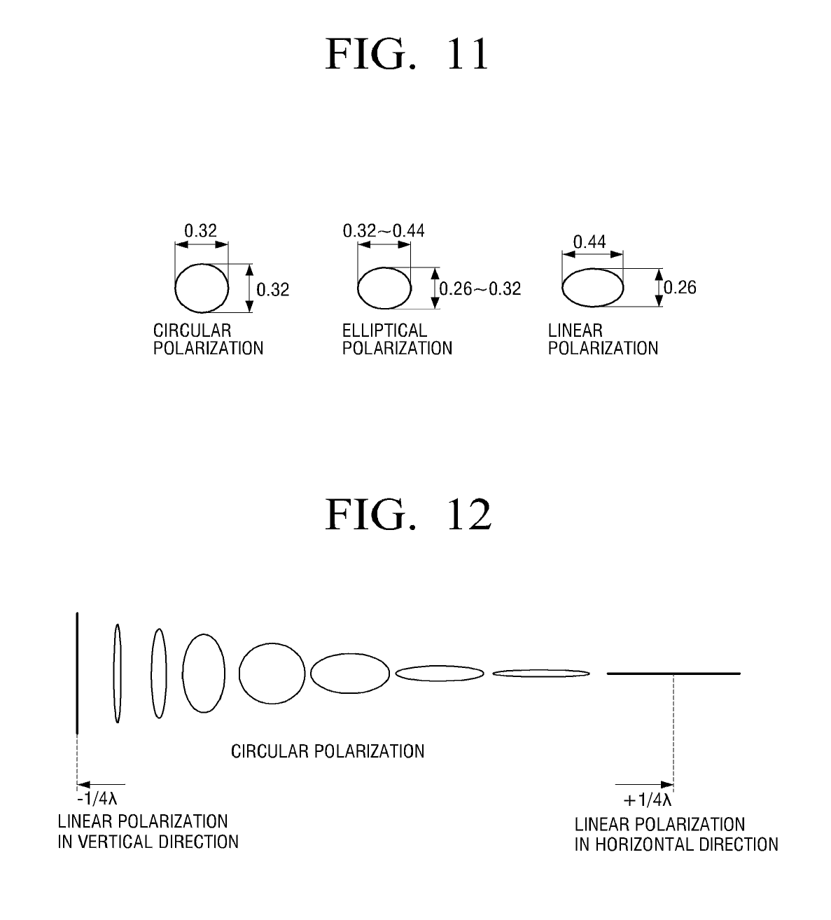

The formation of the optical spot according to the type of the polarization is described with reference to FIG. 11. FIG. 11 depicts a shape of the optical spot according to each type of polarization when the NA of the objective lens is equal to 0.85.

As illustrated in FIG. 11, if the light inputted to the objective lens is circularly-polarized, the spot is in a circular shape. However, if the light inputted to the objective lens is elliptically-polarized, the spot has a slightly elliptical shape. If the light inputted to the objective lens is linearly-polarized, the spot is mostly in an elliptical shape.

If the NA is 0.85, the optical spot gradually becomes less circular and more elliptical as the degree of the polarization deviates from circular polarization.

FIG. 12 depicts a shape of the polarization of the light according to the phase difference of the polarization plate according to an exemplary embodiment. As illustrated in FIG. 12, if the phase difference of the polarization plate is altered, the ellipticity of the polarization is altered. Moreover, while the ellipticity of the polarization is altered by modulating the phase difference of the polarization plate, the direction of the polarization is not changed. Accordingly, when the ellipticity of the polarization is changed using the phase difference of the polarization plate, the direction of the polarization may be established in a desired direction.

As apparent from the foregoing, the laser beam of the semiconductor laser light source 20 forms an elliptical shape, however, the light may be manipulated to form an optical spot in a circular or other elliptical shapes by modulating the phase difference of the polarization plate. Accordingly, the optical pickup device 100 can form a small circular optical spot using the above-described polarization plate, thereby preventing the jitter phenomenon or the cross torque phenomenon.

A polarization plate 59 in accordance with exemplary embodiments is an optical component which generates a polarization effect by using a preset degree of phase difference. The polarization plate 59 may be a liquid crystal device in which the degree of the phase difference may be adjusted.

The optical pickup device 100 is described as a BD disc according to an exemplary embodiment, however, this it not limited thereto and may be another type of optical disc such as a CD, a DVD, or another disc as would be understood by one of skill in the art.

The optical pickup device 100 of an exemplary embodiment may be mounted to any of various optical disc devices to enable reading of and writing to an optical disc. For example, an optical disc device including the optical pickup device 100 may be a BD player, a BD drive, or another type of optical disc device as would be understood by one of skill in the art.

The foregoing exemplary embodiments and advantages are merely exemplary and are not to be construed as limiting the present inventive concept. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An optical pickup device comprising:
a light source which outputs linearly-polarized light having an elliptical shape;
a lens which focuses light outputted from the light source; and
a polarization plate which is disposed on an optical path between the light source and the lens, and which polarizes the light outputted from the light source and transmits elliptically-polarized light, wherein the polarization plate is disposed such that a major axis of the elliptical polarization of the light transmitted by the polarization plate is parallel to a major axis of the elliptical shape of the light.

2. The device as claimed in claim 1, wherein the polarization plate has a phase difference such that the an optical spot formed on an optical disc by the lens has a circular shape.

3. The device as claimed in claim 2, wherein a wavelength of the light outputted by the light source is λ, and the polarization plate has a phase difference which is more than ¼λ and equal to or less than 3/10λ.

4. The device as claimed in claim 1, wherein the polarization plate has a phase difference such that a ratio of a major axis of an optical spot, formed on an optical disc by the lens, to a minor axis of the optical spot is equal to or greater than 0.9 and equal to or less than 1.

5. The device as claimed in claim 1, wherein the major axis of the elliptical polarization of the light transmitted by the polarization plate and the major axis of the elliptical shape of the light are parallel to an information track direction of an optical disc on which the lens forms an optical spot.

6. The device as claimed in claim 1, wherein the objective lens has a numerical aperture of 0.85 or more.

7. An optical disc apparatus comprising an optical pickup device as claimed in claim 1.

8. An optical pickup device comprising:
a light source which outputs a linearly-polarized light having an elliptical shape;
a lens which focuses light outputted from the light source; and
a polarization plate which is disposed on an optical path between the light source and the lens, and which polarizes the light outputted from the light source and transmits elliptically-polarized light, wherein the polarization plate is disposed such that a major axis of the elliptical polarization of the light transmitted by the polarization plate is perpendicular to a major axis of the light.

9. The device as claimed in claim 8, wherein the polarization plate has a phase difference such that a major axis of an optical spot formed on an optical disc by the objective lens is perpendicular to an information track direction of the optical disc.

10. The device as claimed in claim 9, wherein a wavelength of the light outputted by the light source is λ, and the polarization plate has a phase difference which is more than ⅕λ and equal to or less than ¼λ.

11. The device as claimed in claim 8, wherein the lens has a numerical aperture of 0.85 or more.

12. An optical disc apparatus comprising an optical pickup device as claimed in claim 8.

13. The device as claimed in claim 10, wherein the polarization plate has a phase difference which is 2/9.

14. An optical pickup device comprising:
a light source which outputs linearly-polarized light having an elliptical shape and a wavelength λ;
a lens which focuses the light outputted by the light source and which has a numerical aperture of 0.85;
a polarization plate which is disposed between the light source and the lens and which polarizes the light incident thereon and transmits elliptically-polarized light, wherein a major axis of the elliptical polarization of the light transmitted by the polarization plate is one of parallel to and perpendicular to a major axis of the elliptical shape of the light transmitted by the polarization plate, and wherein a phase difference of the polarization plate is 2/9λ.
